(19) United States
(12) Patent Application Publication
(10) Pub. No.: US 2015/0329154 A1
(43) Pub. Date: Nov. 19, 2015

(54) TRACK SYSTEM FOR A VEHICLE

(71) Applicant: BOMBARDIER RECREATIONAL PRODUCTS INC., Valcourt (CA)

(72) Inventor: Charles ROY, Orford (CA)

(21) Appl. No.: 14/806,970

(22) Filed: Jul. 23, 2015

Related U.S. Application Data
(63) Continuation of application No. PCT/US2013/023116, filed on Jan. 25, 2013.

(51) Int. Cl. B62D 55/04; B62D 55/10; B62D 55/065; B62D 55/30; B62D 55/14

(52) U.S. Cl. CPC B62D 55/04; B62D 55/305; B62D 55/14; B62D 55/065; B62D 55/10

(57) ABSTRACT

A track system for a vehicle traveling on a ground. An endless track is connected to a frame by a plurality of wheels rotatably connected to the frame. A track contact area portion supports the vehicle on flat ground. A corner idler wheel is rotatably mounted on a shaft movably connected to the frame by an adjuster. A track portion extends from the corner idler wheel towards the contact area portion defining an attack angle with respect to the flat ground. The corner idler wheel is thereby movable at least between a first position having a first track tension and a first attack angle, and a second position having a second track tension and a second attack angle. The first and the second track tensions are substantially the same. The second attack angle is larger than the first attack angle. Vehicles having the track system are also disclosed.

### CROSS-REFERENCE

The present application is a continuation of International Patent Application No. PCT/US2013/023116 filed on Jan. 25, 2013, the entirety of which is incorporated herein by reference.

### FIELD OF THE INVENTION

The present invention relates generally to track systems for vehicles.

### BACKGROUND

All-terrain vehicles (ATVs) are designed to travel over various types of terrain. The wheels of ATVs are generally equipped with low pressure tires (i.e. “balloon tires”) which have a larger contact area with the ground than high pressure tires. A larger contact area with the ground increases traction and also reduces the pressure exerted on the ground by the tire, which is advantageous for travel over soft terrains like mud, sand or snow.

ATVs are sometimes provided with endless belt systems, also known as endless track systems or track kits, which provide an even larger contact area than wheels having balloon tires. Many types of endless track systems exist. For example, some endless track systems have been designed to be added over the wheels of an ATV. Sometimes either a number of additional wheels or a track supporting structure is required to be added to the existing vehicle. Other endless track systems have been designed to completely replace the wheels.

The increased contact area provided by the endless tracks is particularly advantageous for travel on surfaces covered with snow where the larger contact area of the endless tracks provides improved floatation and increased traction. Endless tracks are also becoming popular for use on surfaces not covered with snow as the endless tracks are better able to move over obstacles that may be present on uneven terrain. It would be useful to be able to adjust the tracks for travel over different types of terrains. For example, the tracks may need to have larger attack angles for travelling on surfaces having larger obstacles. When traveling on soft surfaces, flotation of the ATV may be a bigger concern than the attack angle of the tracks. When the endless track is not capable of adapting to the uneven surface, the contact area with the ground surface decreases, leading to a decrease in traction and flotation.

There is thus a need for an endless track system for a vehicle which can track the shape of the terrain while also providing adequate flotation and traction for operation of the vehicle in differing conditions and on different surfaces.

### SUMMARY

It is an object of the present invention to ameliorate at least some of the inconveniences present in the prior art.

In one aspect, the present provides a track system for a vehicle traveling on a ground, the track system includes a frame. An endless track is connected to the frame by a plurality of wheels. Each of the plurality of wheels is rotatably connected to the frame. A contact area portion of the track supports the vehicle on the ground when the track system is on the vehicle, the vehicle is on the ground, and the ground is flat. A shaft is movably connected to the frame. A corner idler wheel of the plurality of wheels is rotatably mounted on the shaft. A portion of the track extends from the corner idler wheel towards the contact area portion defining an attack angle with respect to the flat ground. An adjuster movably connects the shaft to the frame, the corner idler wheel being thereby movable at least between a first position and a second position. The track has a first track tension and the attack angle is a first attack angle when the corner idler wheel is in the first position. The track has a second track tension and the attack angle is a second attack angle when the corner idler wheel is in the second position. The first track tension and the second track tension are substantially the same. The second attack angle is larger than the first attack angle.

In another aspect, the adjuster includes a cylinder having a central cylindrical axis extending parallel to the shaft, the shaft being fixed to an inner cylindrical surface of the cylinder, the cylinder being selectively rotatable about the central cylindrical axis. A fastener is fixed to the frame and selectively fastened to the cylinder to selectively allow and prevent rotation of the cylinder about the central cylindrical axis.

In another aspect, the fastener is a cylindrical clamp including a curved portion extending circumferentially along at least a portion of an outer cylindrical surface of the cylinder.

In yet another aspect, the cylindrical clamp further includes a tab at each of two ends of the curved portion. The two ends are spaced in a circumferential direction of the cylinder. The tabs are movable relative to one another in the circumferential direction for tightening and loosening of the cylindrical clamp extending around the cylinder.

In a further aspect, the adjuster includes a slot defined in a plate fixed to the frame. The shaft is received in the slot and moveable therein at least between a first shaft position and a second shaft position corresponding respectively to the first and second positions of the corner idler wheel. A fastener fixed to the shaft and selectively fastens the plate to the shaft at least in the first shaft position and the second shaft position

In an additional aspect, the slot includes a first arm and a second arm connected together and extending at an acute angle with respect to each other. The shaft is disposed in the first arm when in the first shaft position and in the second arm when in the second shaft position.

In another aspect, at least a portion of the lower surface of the frame between the corner idler wheel and a wheel connected to the contact area portion extends upwards towards the corner idler wheel away from the contact area portion.

In yet another aspect, the plurality of wheels includes a sprocket wheel connecting the track to the frame. The sprocket wheel is rotatably connected to the frame and operatively connectable to an engine of the vehicle to be rotated thereby. The sprocket wheel engages an inner surface of the track to drive the track.

In a further aspect, the sprocket wheel is connected to an upper portion of the frame.

In another aspect, the present provides a vehicle including a vehicle frame defining a longitudinal direction and a lateral direction. An engine is connected to the vehicle frame. The vehicle includes at least one track system having any one of the aspect mentioned above and being operatively connected to the engine.

In an additional aspect, for at least one of the at least one track system, the attack angle is a forward attack angle, and the corner idler wheel is a front corner idler wheel.

In a further aspect, the at least one track system includes a front left track system, a front right track system, a rear left track system, and a rear right track system.

For purposes of the present application, terms related to spatial orientation when referring to a vehicles and components in relation to the vehicles, such as “forwardly”, “rearwardly”, “left”, “right”, “above” and “below”, are as they would be understood by a driver of the vehicle, with the vehicle in a straight ahead orientation (i.e. not steered left or right). The explanations provided above regarding the above terms take precedence over explanations of these terms that may be found in the document incorporated herein by reference.

Embodiments of the present invention each have at least one of the above-mentioned object and/or aspects, but do not necessarily have all of them. It should be understood that some aspects of the present invention that have resulted from attempting to attain the above-mentioned object may not satisfy this object and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1A is a perspective view taken from a front, left side of an all-terrain vehicle (ATV) having four wheels;

FIG. 1B is a left side elevation view taken from a front, left side of an ATV in which each of the four wheels has been replaced with a track kit;

FIG. 2 is a right side elevation view of a front right track kit of the ATV of FIG. 1B which replaces the front right wheel of the ATV of FIG. 1A;

FIG. 3 is a perspective view, taken from a top, rear and right side, of the track kit of FIG. 2, shown with the track removed for clarity;

FIG. 4 is a top plan view of the track kit of FIG. 3;

FIG. 5A is a right side elevation view of the track kit of FIG. 3 with a mounting shaft for a pair of front corner idler wheels in a position corresponding to a low forward attack angle and with the right one of the pair of front corner idler wheels removed to show an adjuster;

FIG. 5B is a right side elevation view of the track kit of FIG. 3 with the mounting shaft in a position corresponding to a high forward attack angle;

FIG. 6A is a right side elevation view of a rear right track kit of the ATV of FIG. 1B with a mounting shaft for a pair of rear corner idler wheels in a position corresponding to a low rearward attack angle, shown, for clarity, with only a portion of the track contacting the rear corner idler wheels, and without a right one of the pair of rear corner idler wheels to show the adjuster;

FIG. 6B is a right side elevation view of the track kit of FIG. 6A with the mounting shaft in a position corresponding to a high rearward attack angle;

FIG. 7A shows a cross-sectional view of the track kit of FIG. 6A taken along the line A-A of FIG. 6A;

FIG. 7B shows a cross-sectional view of the track kit of FIG. 6B taken along the line B-B of FIG. 6B;

FIG. 8A is a partially exploded perspective view, taken from a front, left side, of a rear left track kit having an adjuster according to another embodiment, shown with a mounting shaft for a pair of front corner idler wheels in a position corresponding to a low rearward attack angle, the left one of the pair of rear corner idler wheels removed to show the adjuster and the track removed for clarity; and

FIG. 8B is a partially exploded perspective view, taken from a front, left side, of the rear left track kit of FIG. 8A with the mounting shaft in a position corresponding to a high rearward attack angle.

### DETAILED DESCRIPTION

The present invention is being described throughout this description with reference to a four-wheeled all-terrain vehicle (ATV) in which one or more of the four wheels is replaced with a track kit. It is however contemplated that aspects of the invention could be used in other vehicles having at least one track, such as snowmobiles and the like, or in vehicles that can be provided with track kits.

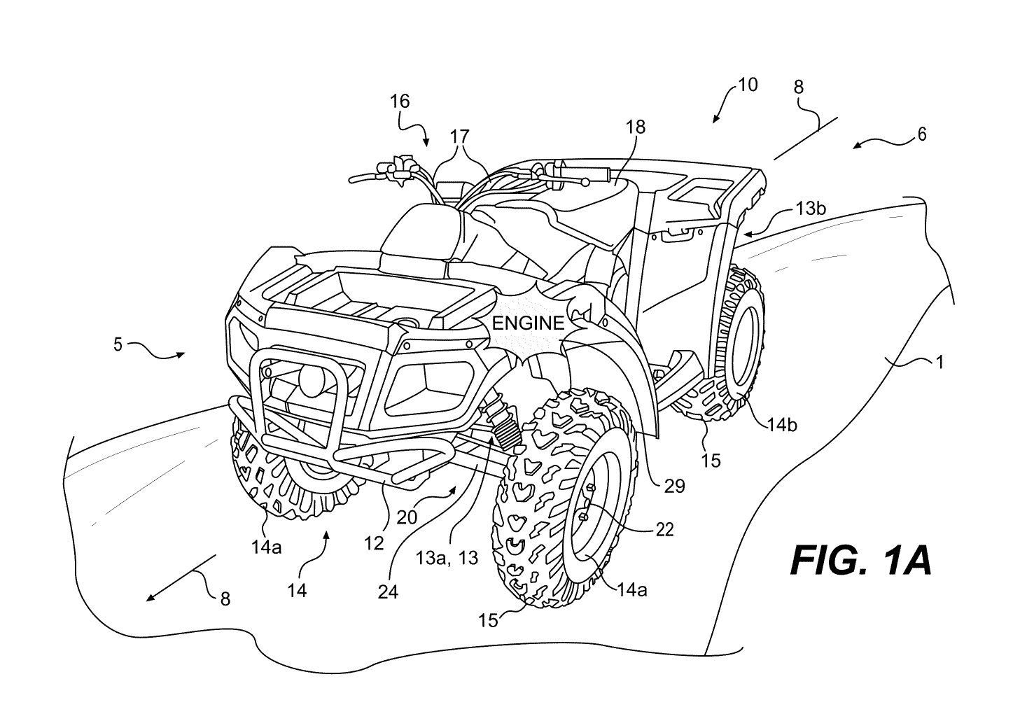

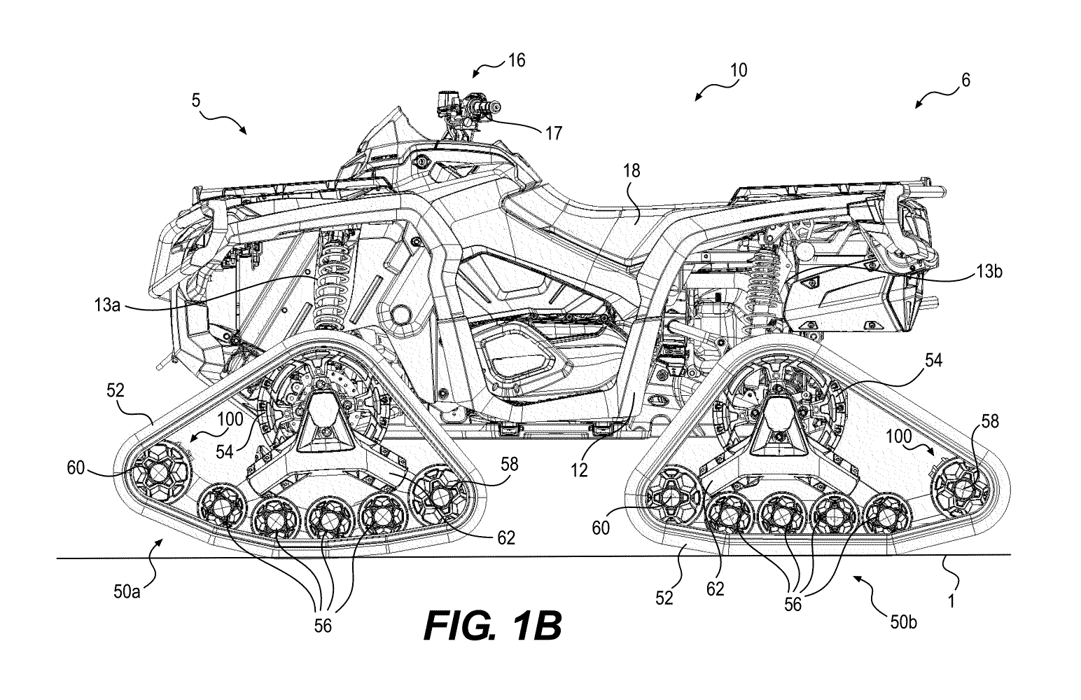

With reference to FIG. 1A, the ATV 10 operating on a surface 1 has a front end 5 and a rear end 6 defined consistently with the forward travel direction. The ATV 10 has a central longitudinal axis 8.

The ATV 10 has a vehicle frame 12. Suspension assemblies 13 supporting wheels 14 are connected to the vehicle frame 12. The wheels 14 include a front left wheel 14a, a front right wheel 14a, a rear left wheel 14b and a rear right wheel 14b. Each wheel 14 is mounted to a hub 22 and provided with a low-pressure balloon tire 15 adapted for off-road conditions and rugged terrain. Although the ATV 10 of the illustrated embodiment has two front wheels 14a and two rear wheels 14b, it is contemplated that the ATV 10 could also have more than two rear wheels.

Each front wheel 14a is suspended from the frame 12 by a front suspension assembly 13a and each rear wheel 14b is suspended from the frame 12 by a rear suspension assembly 13b (FIG. 1B). Each suspension assembly 13a, 13b is an A-arm type suspension having an A-arm and a shock absorber connected at its upper end to the vehicle frame 12 and at its lower end to the A-arm. It is contemplated that any suitable types of suspension systems could be provided, such as, for example, a single or double swing arm suspension system, a McPherson suspension system or a double A-arm type suspension and the like.

A straddle seat 18 is mounted to the frame 12 for supporting a driver. An internal combustion engine 29 (schematically shown in FIG. 1A) powering the ATV 10 is mounted to the vehicle frame 12 below the straddle seat 18. The engine 29 is a V-type internal combustion engine. As will be readily appreciated by those of ordinary skill in the art, other types and configurations of engines can be substituted. The crankshaft (not shown) of the engine 29 is coupled to a drivetrain 20 for driving the wheels 14.

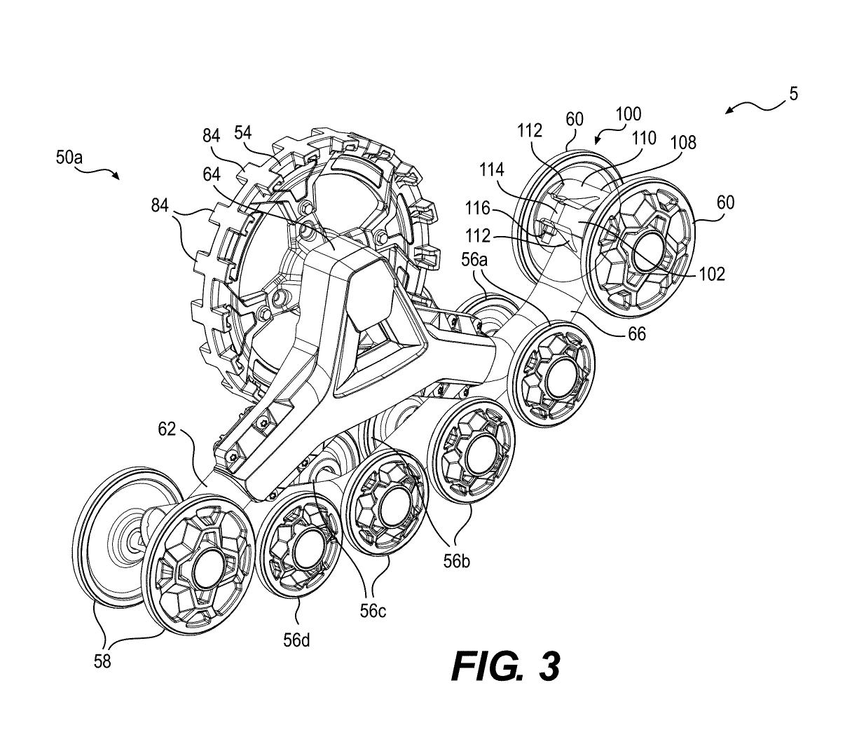

The drivetrain 20 delivers torque from the engine 29 to the wheels 14. The drivetrain 20 is connected to the wheels 14 via a longitudinally extending drive shaft (not shown) connected to the crankshaft, a differential (not shown) and a laterally extending half shaft 24 connected to the hub 22. Each hub 22 and wheel 14 rotates about a hub axis 23 (FIG. 3) to propel the vehicle 10. In the illustrated embodiment, the drivetrain 20 provides four-wheel drive (4WD). It is also contemplated that the drivetrain 20 could selectively deliver torque to one or more of the wheels 14 to provide one-wheel-drive (1WD), two-wheel-drive (2WD), three-wheel-drive (3WD) or four-wheel-drive (4WD).

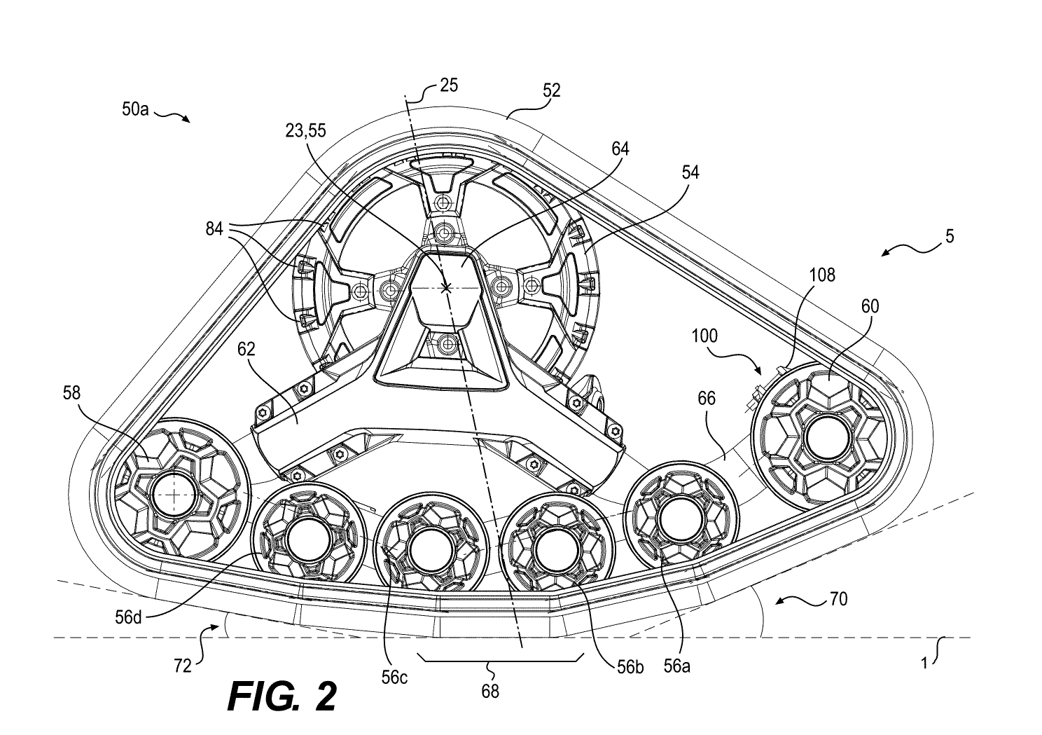

The ATV 10 further includes a steering mechanism 16 which is rotationally supported by the frame 12 to enable a driver to steer the vehicle 10. The steering mechanism 16 includes handlebars 17 connected to a steering column (not shown) for actuating steering linkages connected to the hubs 22 of the left and right front wheels 14a. Each hub 22 turns about a steering axis 25 (FIG. 2) passing through the center of the hub 22 and extending generally vertically.

The vehicle 10 has other features and components such as fenders, headlights and radiators. As it is believed that these features and components would be readily recognized by one of ordinary skill in the art, further explanation and description of these components will not be provided herein. U.S. Pat. No. 7,712,557 B2, issued May 11, 2010 and incorporated herein by reference, provides additional details regarding an all-terrain vehicle similar to the ATV 10 described herein.

FIG. 1B illustrates an ATV 10, similar to the ATV 10 of FIG. 1A, in which each of the wheels 14 has been replaced with an endless track system 50, also referred to as a track kit 50. Each front wheel 14a has been replaced by a front track kit 50a and each rear wheel 14b has been replaced with a rear track kit 50b. The track kits 50a, 50b are thus operatively connected to the engine 29 via the hub 22 to propel the ATV 10.

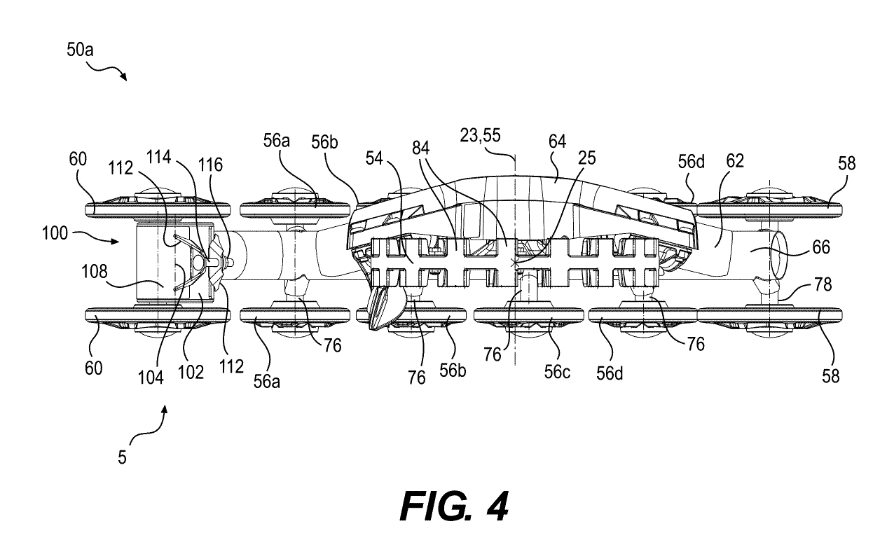

The front track kit 50a will now be discussed with reference to FIGS. 2 to 5B. The front left track kit 50a is a mirror image of the front right track kits 50a, and as such only the front right track kit 50a will be described below in detail.

The front right track kit 50a includes an endless belt or endless track 52, a sprocket wheel 54, eight middle idler wheels 56, a pair of rear corner idler wheels 58, and a pair of front corner idler wheels 60. The track kit 50a also includes a frame 62 supporting the wheels 54, 56, 58, 60 and the track 52.

The track 52 is placed around the wheels 54, 56, 58, 60 which define the path over which the track 52 moves. The path of the track 52 is defined in the upper portion by the sprocket wheel 54, in the forward and rearward portions by the corner wheels 58, 60, and in the bottom portion by the middle idler wheels 56. The wheels 54, 56, 58, 60 are positioned so as to keep the track 52 tensioned.

In the illustrated embodiment, the idler wheels 56, 58, 60 are arranged in pairs of laterally spaced and longitudinally aligned left and right idler wheels. It is contemplated that at least some of the pairs of idler wheels 56, 58, 60 could be a single wheel centered in the track 52. In the illustrated embodiment, the track kit 50a has four pairs of middle idler wheels 56a, 56b, 56c, 56d. It is however contemplated that there could be more or less than four pairs of middle idler wheels 56. It is contemplated that some of the left and right middle idler wheels 56, could not be arranged as pairs of longitudinally aligned wheels.

The corner idler wheels 58, 60 are larger in diameter than the middle idler wheels 56. The large diameter of corner wheels 56, 58 helps to push snow on the ground 1 ahead of the ATV 10 under the ATV 10 and also aids the ATV 10 in moving over the obstacles. It is also contemplated that the relative size of the wheels 54, 56, 58, 60 could be different than as shown.

The engine 29 rotates the sprocket wheel 54 via the hub 22. The sprocket wheel 54 is coaxially mounted on the hub 22. The sprocket wheel 54 is removeably fastened to the hub 22 so as to rotate therewith. The hub 22 and the sprocket wheel 54 rotate about the hub axis 23 and a sprocket axis 55, which is coaxial with hub axis 23.

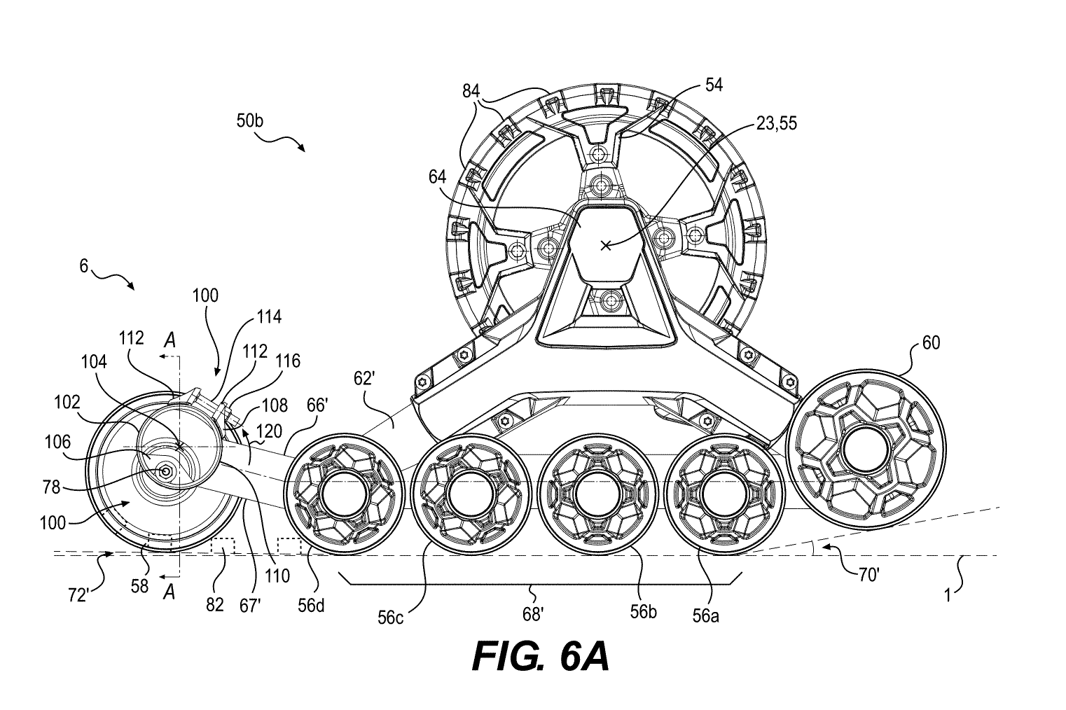

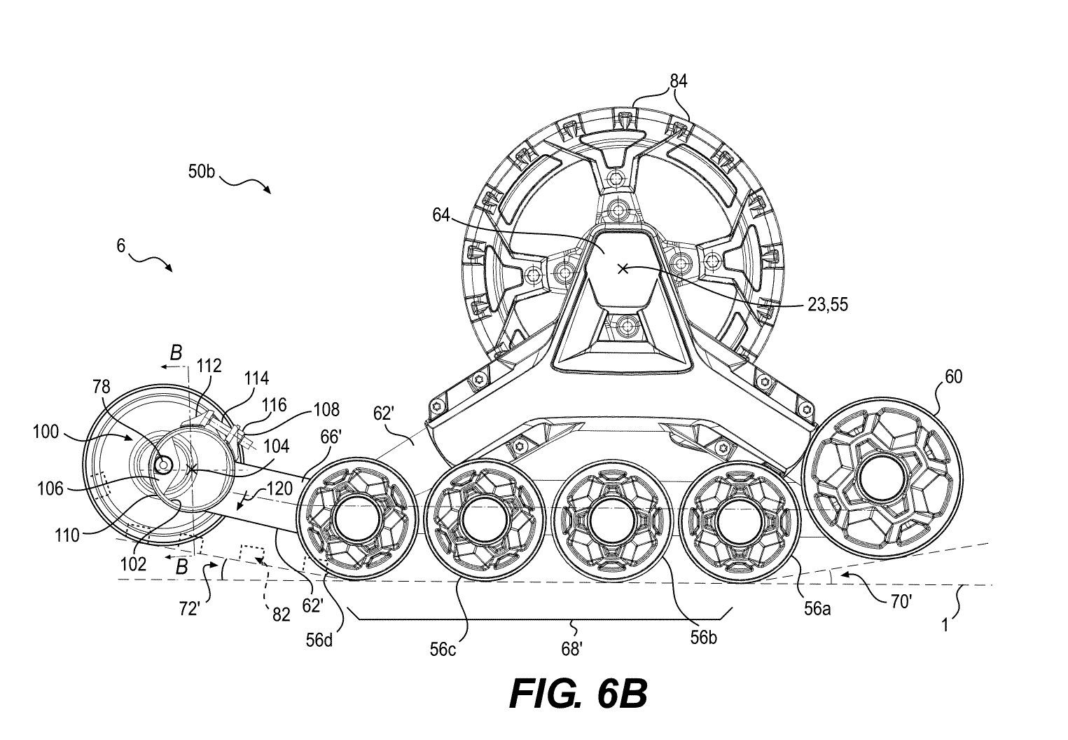

The sprocket wheel 54 is laterally centered with respect to the track 52. The sprocket wheel 54 drives the track 52 by means of the projections 84 extending laterally outwards from its rim which engage complementary lugs 82 (shown in dotted lines in FIGS. 6A and 6B for a portion of the track) on the inner surface of the track 52. The sprocket wheel 54 drives the track 52 over the wheels 56, 58, 60 thereby propelling the ATV 10 over the ground 1. The idler wheels 56, 58, 60 are maintained in their position relative to the sprocket wheel 54 by the frame 62.

The sprocket wheel 54 is connected to an upper portion of the frame 62. A link 64 of the upper portion of the frame 62 connects to the sprocket wheel 54 by roller bearings (not shown) so that the hub 22 and the sprocket wheel 54 can rotate about the axis 23, 55 without rotating the frame 62, or any part thereof. The link 64 is disposed on the right side of the sprocket wheel 54.

The sprocket wheel 54, and thereby the frame 62 and the track 52, turn about the steering axis 25 when the hub 22 is turned for steering the ATV 10.

The frame 62 extends downwards and leftwards (i.e., laterally inwards towards the longitudinal centerline 8) from the link 64 to connect to the lower portion of the frame 62. The lower portion of the frame 62 includes a hollow tubular rail 66 extending longitudinally along the track kit 50a below the sprocket wheel 54. The front portion of the rail 66 curves upwardly and forwardly. The rear portion of the rail 66 curves upwardly and rearwardly. The idler wheels 56, 58, 60 are rotatably mounted to the rail 66. The upper portion of the frame 62 is rigidly fastened to the lower portion of the frame 62. It is also contemplated that the upper and lower portions of the frame 62 could be formed integrally. In the illustrated embodiment, the frame 62 is rigid and made of carbon steel.

The middle idler wheels 56 are connected to a middle section of the rail 66. Four middle shafts 76 extend laterally through the middle section of the rail 66 and are welded thereto. Each middle shaft 76 has mounted thereon a pair of middle idler wheels 56. The left middle idler wheel 56 is mounted rotatably at the left end of the middle shaft 76. The right middle idler wheel 56 is mounted rotatably at the right end of the middle shaft 76

The rear corner idler wheels 58 are connected to the rear end of the rail 66. A rear shaft 78 extends laterally through the rear end of the rail 66 and is welded thereto. The rear left corner idler wheel 58 is mounted rotatably at the left end of the rear shaft 78. The rear right corner idler wheel 58 is mounted rotatably at the right end of the rear shaft 78.

The front corner idler wheels 60 are connected to the front end of the rail 66. The left and right front corner idler wheels 60 are respectively mounted rotatably at the left and right ends of the front shaft 80. The front shaft 80 is connected to the front end of the rail 66 by means of an adjuster 100 which will be discussed below in further detail.

The shafts 76, 78, 80 disposed in the respective centers of the idler wheels 56, 58, 60 are positioned at different vertical positions. The first (forwardmost) and the fourth (rearwardmost) middle idler wheels 56a, 56d are disposed vertically higher than the second and third middle idler wheels 56b, 56c which are at the lowest vertical position. The first middle idler wheels 56a are disposed vertically higher than the fourth middle idler wheels 56d.

The bottom of the wheels 56, 58, 60 define the shape of the ground engaging portion of the track 52. The wheels 56, 58, 60 are positioned and dimensioned such that the ground engaging lower portion of the track 52 curves upwardly towards the front and the rear which helps the endless track system 50 to move over obstacles on the ground 1.

The portion of the track 52 below the second and third middle idler wheels 56b, 56c, which are the lowest idler wheels, form the contact area 68 of the track 52 with the ground 1 when the ground 1 is flat and rigid. The contact area 68 is the portion of the endless track 52 that is in contact with the ground 1 for most of the time and through which (in most instances) the load is transmitted to the ground 1. It is contemplated that one, three or all four of the middle idler wheels 56 could be disposed at the same vertical position so as to form a larger contact area 68 on level ground 1 than in the illustrated embodiment.

The front corner idler wheels 60 are disposed vertically higher than the first middle idler wheels 56a. The portion of the track 52 between the front corner idler wheels 60 and the first middle idler wheels 56a forms a forward angle of attack 70 with respect to the contact area 68 of the track 52. The position of the front corner idler wheel 60 can be adjusted, via the adjuster 100, to change the forward angle of attack 70. The forward attack angle 70 may be adjusted to optimize for particular characteristics of the terrain, for example, the forward attack angle 70 could be adjusted based on the type of obstacles or the rigidity of the ground 1 being traversed by the ATV 10. With an increased attack angle 70, the track 52 is less likely to be pushed towards the left or right while travelling over obstacles and crevices. The track 52 will instead roll smoothly over the obstacles and/or crevices. Increasing the attack angle 70 also reduces feed-back from the steering mechanism 16 to the driver operating the steering mechanism 16 as the vehicle 10 travels over obstacles and crevices on the ground 1.

The position of the front corner idler wheels 60 is also adjusted to change the track tension. When the front corner idler wheels 60 are repositioned relative to the wheels 54, 56a, the total peripheral distance of the track kit 50a as defined by the wheels 54, 58, 56, 60 changes. The track tension accordingly increases or decreases with the total peripheral distance of the track kit 50a. The endless track 52 can be removed from the track kit 50a for maintenance and replacement by repositioning the front corner idler wheels 60 such that the track 52 becomes slack.

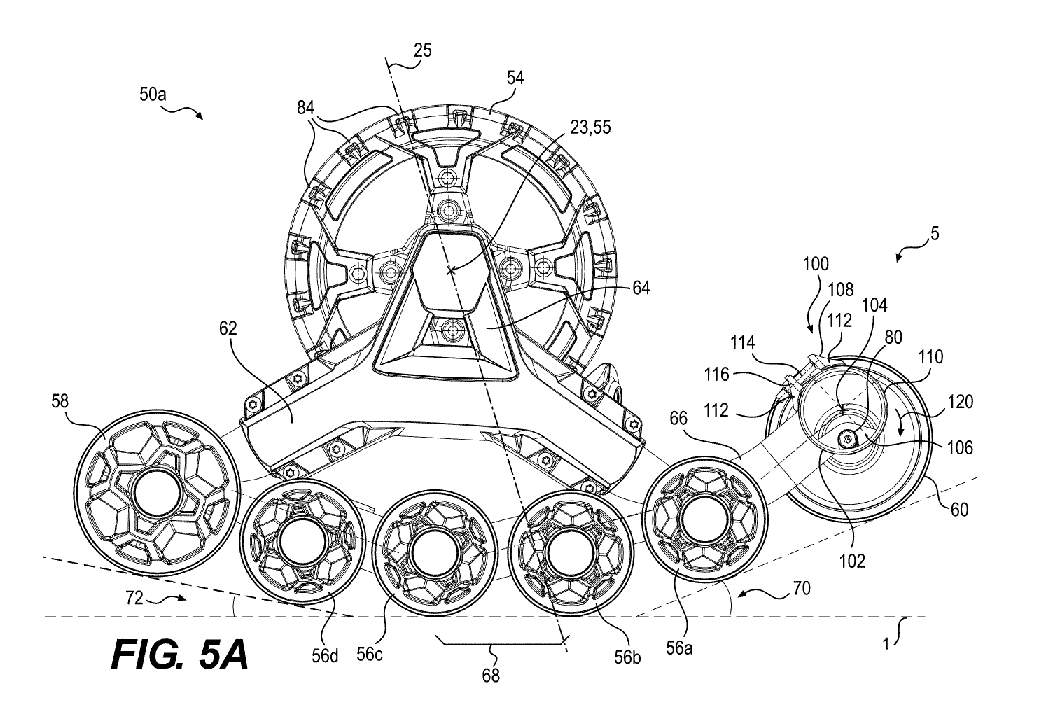

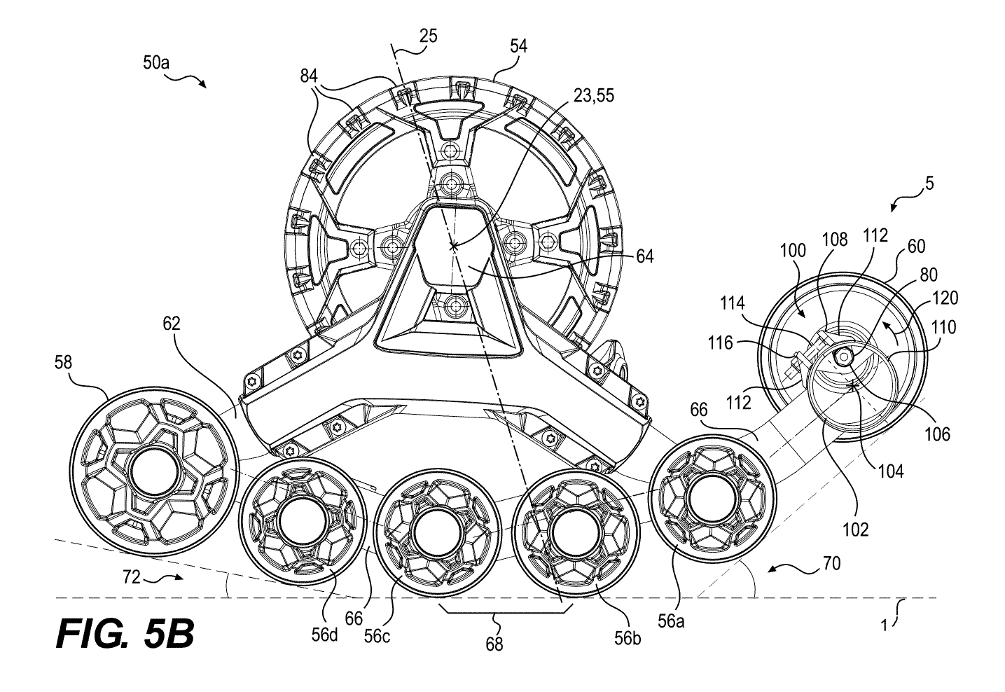

Figure SA shows the front corner idler wheels 60 in a position corresponding to a low forward attack angle 70 in Figure SA while in FIG. 5B, the corner idler wheels are in a position corresponding to a high forward attack angle 70. As will be discussed below, these two positions of the front corner idler wheels 60 shown in FIGS. 5A and 5B however provide substantially the same track tension even though the forward attack angles 70 are different.

The rear corner idler wheels 58 are disposed vertically higher than the fourth middle idler wheels 56d. The portion of the track 52 between the rear corner idler wheels 58 and the rearwardmost middle idler wheel 56d forms a rearward angle of attack 72 with respect to the contact area 68 of the track 52. In the illustrated embodiment of the front track kit 50a, the rearward attack angle 72 is fixed. It is however contemplated that the rearward attack angle 72 could also be adjustable.

The front corner idler wheels 60 are disposed vertically higher than the rear corner idler wheels 58 so that the forward attack angle of attack 70 is greater than the rearward angle of attack 72. It is however contemplated that the forward attack angle 70 could be less than or equal to the rearward attack angle 72.

The rear track kits 50b will now be described with reference to FIGS. 6A and 6B. The rear left track kit 50b and the rear right track kit 50b are mirror images of each other and as such, only the rear right track kit 50b, which is shown in these figures, will described. Furthermore, corresponding features of the front and rear track kits 50a, 50b have been labeled with the same reference numbers and will not be described again in detail except to explain their differences if any. An apostrophe has been added after the reference number for features of the rear track kit 50b that are different from the corresponding features of the front track kit 50a.

Similar to the front track kit 50a, the rear track kit 50b includes an endless track 52, a frame 62′, a sprocket wheel 54, four pairs of middle idler wheels 56, a pair of rear corner idler wheels 58, and a pair of front corner idler wheels 60.

The wheels 54, 56, 58, 60 of the rear track kit 50b have the same dimensions as that of the front track kit 50a. It is contemplated that the number and dimension of the wheels 54, 56, 58, 60 of the rear track kit 50b could be different than in the front track kit 50a.

The sprocket wheel 54 of the rear track kit 50b is connected to the engine 29 via the hub 22 as in the front track kit 50a. The rear track kit 50b, however, is not connected to the steering mechanism 16.

All four pairs of the middle idler wheels 56a, 56b, 56c, 56d of the rear track kit 50b are disposed at the same vertical position. The entire length of the track 52 between the first and the fourth middle idler wheels 56a, 56d therefore forms the contact area 68′ for the track 52. The contact area 68′ of the rear track kit 50b is thus larger than the contact area 68 of the front track kit 50a. The contact area 68 is made relatively smaller in order to decrease the load on the steering mechanism 16 and to facilitate steering of the ATV 10. The larger contact area 68′ of the rear track kit 50b, on the other hand, aids in flotation of the ATV 10 on soft surfaces 1 such as those covered with snow.

The frame 62′ of the rear track kit 50b has an upper portion having a link 64 which is similar to the upper portion and link 64 of the front track kit 50a. The lower portion of the frame 62′ has a rail 66′ which is different in shape than the rail 66 of the front track kit 50a.

The rail 66′ extends substantially horizontally curving upwards only at the rear end 67′. The front corner idler wheels 60 are mounted at a higher vertical position than the first middle idler wheels 56a so that the rear track kit 50b has a non-zero forward attack angle 70′. The front mounting shaft (not shown) is however directly connected to the rail 66′ so that the forward attack angle 70′ is not adjustable. It is contemplated that the front mounting shaft could be connected to the rail 66′ via an adjuster 100 so that forward attack angle 70′ is adjustable as in the front track kit 50a. The forward attack angle 70′ in the illustrated embodiment of the rear track kit 50b is smaller than the low forward attack angle 70 of the front track kit 50a. It is however contemplated that the rear track kit 50b could be configured to have a different fixed or adjustable forward attack angle 70′ than as shown.

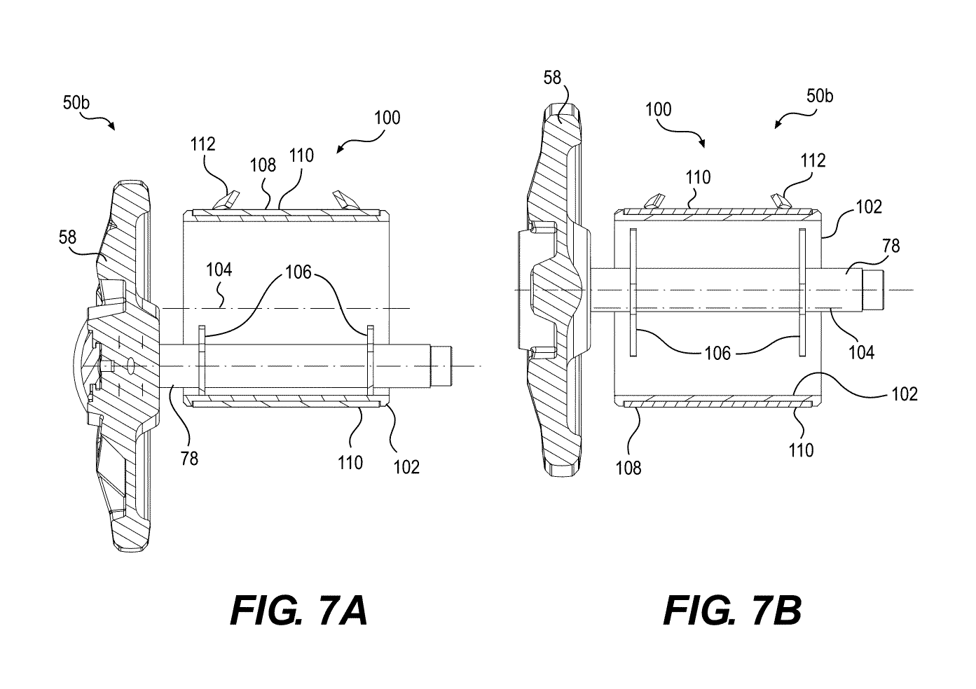

The rear mounting shaft 78 (FIGS. 7A and 7B) is connected to the rail 66′ via an adjuster 100 similar to the adjuster 100 of the front mounting shaft 80 of the front track kit 50a. The rearward attack angle 72′ is thus adjustable between a low rearward attack angle 72′ (FIG. 6A) and a high rearward attack angle 72′(FIG. 6B). The high rearward attack angle 70′ is approximately the same as the fixed rearward attack angle 72 in the front track kit 50a. It is contemplated that the rear track kit 50b could be configured to have different rearward attack angles 72′ than as shown in FIGS. 6A and 6B.

Turning now to FIGS. 6A to 7B, the adjuster 100 will be described with reference to the rear track kit 50b, however, it should be understood that the description also applies to the adjuster 100 of the front track kit 50a shown in FIGS. 5A and 5B.

The adjuster 100 is an eccentric mechanism for mounting the rear shaft 78. The adjuster 100 includes a cylinder 102 disposed between the rear left and right corner idler wheels 58 such that a central axis 104 of the cylinder 102 is parallel to the rear shaft 78 to which the wheels 58 are mounted. The rear shaft 78 passes through the cylinder 102. The rear shaft 78 is fixed to the inner surface of the cylinder 102 by brackets 106 and is therefore offset from the central axis 104 of the cylinder 102.

The cylinder 102 is seated within a variable diameter cylindrical clamp 108 which is fixed to the rail 66′. The clamp 108 includes two tabs 112 connected to each other by a curved portion 110. The rail 66′ is connected to an outer surface of the curved portion 110. The curved portion 110 wraps around the outer surface of the cylinder 102. The tabs 112 project outwardly from the end of the curved portion 110. The tabs 112 can be drawn towards each other to decrease the diameter of the clamp 108, thereby tightening the clamp 108 around the cylinder 102. Similarly, pushing the tabs 112 away from each other increases the diameter of the clamp 108, slackening its grip over the cylinder 102.

The tabs 112 are fastened to each other by means of a nut 116 and bolt 114. The nut 116 is advanced or retracted along the bolt 116 to tighten or loosen the clamp 108 around the cylinder 102. When the clamp 108 is tightened, the cylinder 102 is prevented from moving and thus fixed to the frame 62′. When the clamp 108 is slackened, the cylinder 102 can be rotated about the cylinder axis 104 inside the clamp 108.

Rotation of the cylinder 102 about the cylinder axis 104 rotates the rear shaft 78 about the cylinder axis 104, changing the position of the wheels 58 relative to the frame 62′ and the fourth middle idler wheels 56d. Rotating the cylinder 102 about the central cylindrical axis 104 thus changes the rearward attack angle 72′ as well as the track tension in the track 52 mounted around the wheels 54, 58, 56, 60.

Typically, the track 52 is adjusted to provide a certain track tension that is optimal based on the operating conditions of the ATV 10 and the surface 1 upon which the ATV 10 is traveling. It is desirable to maintain this track tension even if the attack angles 70, 72, 70′, 72′ are changed, for example, when the unevenness of the surface 1 changes.

For a cylinder 102 of a given diameter, due to the eccentric configuration of the cylinder 102 and the rear shaft 78 in the adjuster 100, there are two positions of the rear shaft 78 (and the rear corner idler wheels 58 mounted thereon) that provide the same track tension in the track 52 but at two different rearward attack angles 72′. The peripheral distance between the fourth idler wheel 56d and the sprocket wheel 54 going around the rear corner idler wheel 58 is the same in these two positions. With reference to FIGS. 6A and 6B, a first position (FIG. 6A) of these two different positions providing the same track tension provides a low rearward attack angle 72′ while a second position (FIG. 6B) provides a high rearward attack angle 72′ compared to the first position. The wheels 58 are longitudinally further from the wheels 56d and vertically closer to the wheels 56d in the first position than in the second position. It will be understood that the values of the rearward attack angles 72′ in the first and second positions will depend on the diameter of the cylinder 102.

The rearward attack angle 72′ is changed by rotating the cylinder 102 so as to rotate the rear shaft 78 from an initial position (one of the first and the second positions) to a final position (the other of the first and the second positions). The cylinder 102, and thereby the rear shaft 78, is rotated in a direction that initially slackens the track 52. For example, in the configuration of the adjuster 100 shown in FIGS. 6A and 6B, the cylinder 102 is rotated in a counter-clockwise direction 120 as viewed from the right side of the ATV 10 to change the low rearward attack angle 72′ of FIG. 6A to the rearward high attack angle 72′ of FIG. 6B. The rotation is continued until the track 52 begins to tighten once again, past the 180 degree position with respect to the initial position, to the final position. When the final position is reached, the clamp 108 is retightened to maintain the rear shaft 78 in that final position which provides the desired track tension and a different rearward attack angle 72′ than in the initial position. As can be seen in FIGS. 6A and 6B, the rear shaft 78 is disposed in different quadrants of the circular portion 110 of the clamp 108 in the two different positions corresponding to a low and high attack angle 72′.

The rear end 67′ of the rail 66′ slopes upwards, as mentioned above, in order to prevent contact with the lugs 82 of the track 52. The lugs 82 on the inner surface of the track 52 pass under the rail 66′ such that there is no interference between the lugs 82 and the rail 66′ between the wheels 56d and 58, whether the corner idler wheels 58 are in the low or the high rearward attack angle position.

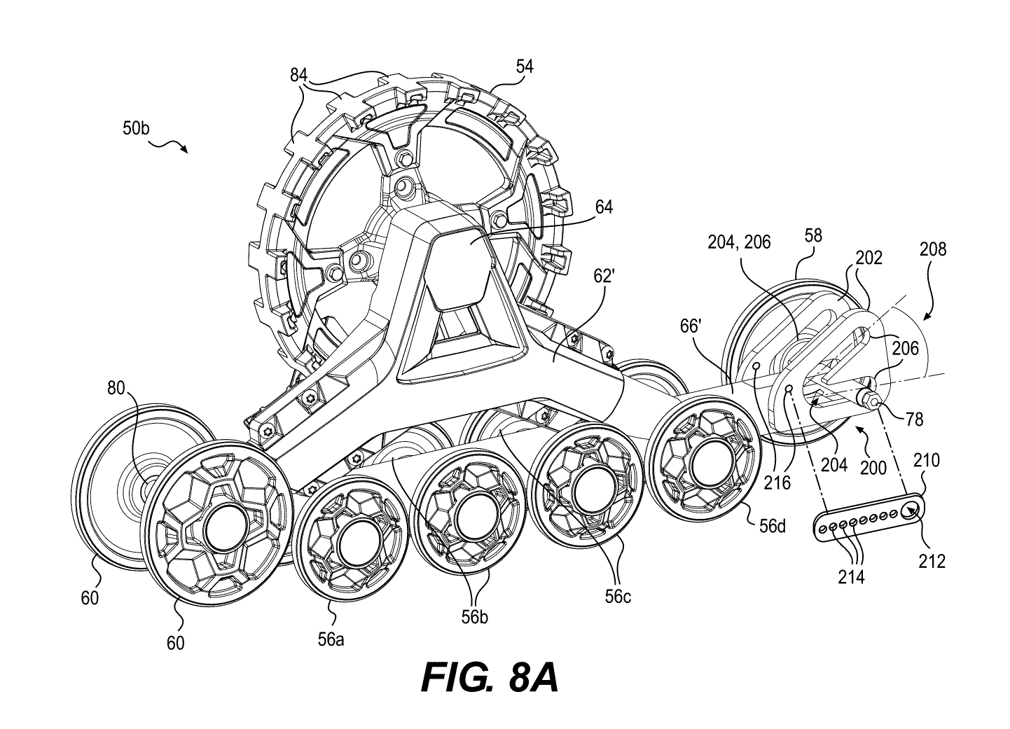

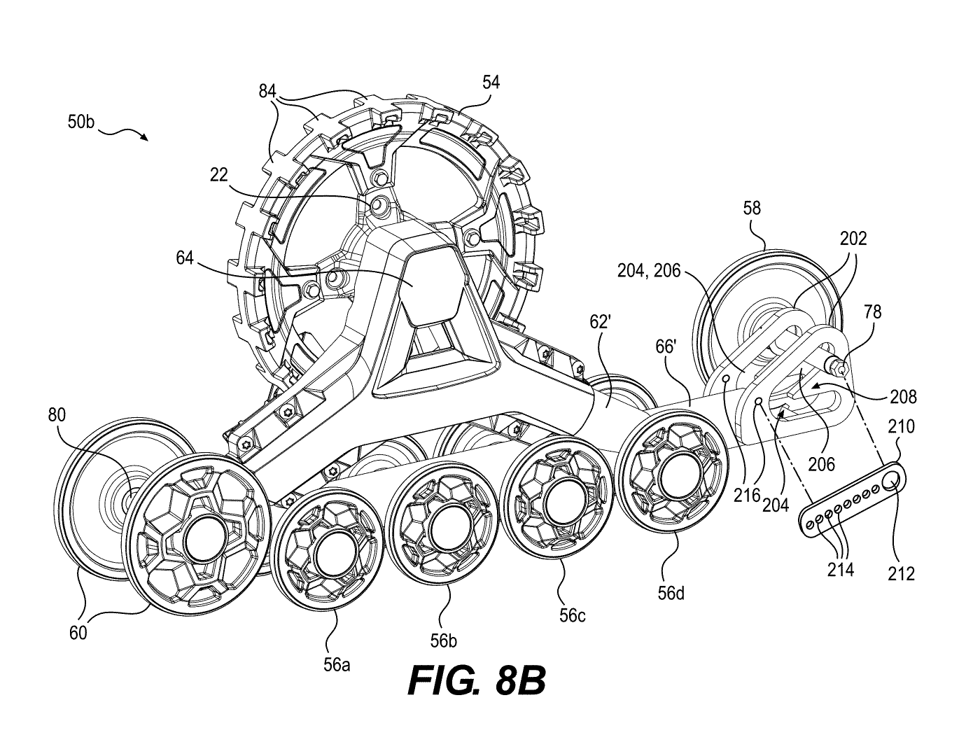

Another embodiment of an adjuster 200 will now be discussed with reference to the track kit 50 shown in FIGS. 8A and 8B. The track kit 50 is a rear track kit 50b similar to the rear track kit 50b of FIGS. 6A and 6B except for the adjuster 200 which is different form the adjuster 100. Corresponding features have therefore been labeled with the same reference numbers and will not be discussed again below.

The adjuster 200 includes a left and right plate 202 fixed to the front end of the rail 66′ on its left and right sides. The rail 66′ is therefore disposed between the plates 202 which extend forwardly therefrom.

Each plate 202 has a V-shaped slot 204. The rear shaft 78 is inserted through the aligned slots 204 of the left and right plates 202. The left and right rear corner idler wheels 58 are mounted respectively at the left and right ends of the rear shaft 78. The left plate 202 is disposed between the rail 66′ and the left wheel (omitted for clarity). The right plate 202 is disposed between the rail 66′ and the right wheel 58.

The rear shaft 78 can be moved within the upper and lower arms 206 of the slot 204 to change the position of the rear corner idler wheels 58 with respect to the middle idler wheels 56, and to thereby change the rearward attack angle 72′ of the track 52.

The rear shaft 78 can be fixed to the plates 202 at a given position in the slot 204 by means of a fastener 210. The fastener 210 has an elongated body with a shaft opening 212 and a series of smaller openings 214. The rear shaft 78 is rotatably inserted through the shaft opening 212. The fastener 210 is fixed to the plate 202 by a bolt (not shown) inserted through one of the holes 214 of the fastener 210 into a hole 216 of the plate 202. The hole 214 is selected so as to position the rear shaft 78 held in the shaft opening 212 in the desired position corresponding to the desired attack angle 72. The rear shaft 78 can be fastened to each plate 202 by a fastener 210, or a single central fastener 210 can be placed between the left and right plates 202 and fastened to both plates 202. It is also contemplated that a fastener similar to the fastener 210 could be used to fasten rear shaft 78 directly to the rail 66′ (for example, to an upper surface of the rail 66′, after the rear shaft 78 has been moved to the desired position in the slot 204. The series of smaller openings 214, in this case, would extend vertically through a horizontally extending portion of the fastener body. It is contemplated that any suitable fasteners could be used to fix the rear shaft 78 in the slot 204.

The two arms 206 of the V-shaped slot 204 are disposed at an acute slot angle 208 with respect to each other. The slot angle 208 and the length of the arms 206 are configured such that a position of the rear shaft 78 in the lower arm 206 (shown in FIG. 8A) provides the same tension in the track 52 as a corresponding position of the rear shaft 78 in the upper arm 206 (shown in FIG. 8B). The rearward attack angles 72′ corresponding to the two positions of the rear shaft 78 in the upper and lower arms 206 which provide the same track tension are, however, different.

It should also be understood that the track kits 50a, 50b could have other configurations of the sprocket and idler wheels and the frame than as described above.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A track system for a vehicle traveling on a ground, the track system comprising:
a frame;
an endless track connected to the frame by a plurality of wheels, each of the plurality of wheels being rotatably connected to the frame;
a contact area portion of the track supporting the vehicle on the ground when the track system is on the vehicle, the vehicle is on the ground, and the ground is flat;
a shaft movably connected to the frame;
a corner idler wheel of the plurality of wheels being rotatably mounted on the shaft;
a portion of the track extending from the corner idler wheel towards the contact area portion defining an attack angle with respect to the flat ground; and
an adjuster movably connecting the shaft to the frame, the corner idler wheel being thereby movable at least between a first position and a second position,
the track having a first track tension and the attack angle being a first attack angle when the corner idler wheel is in the first position,
the track having a second track tension and the attack angle being a second attack angle when the corner idler wheel is in the second position,
the first track tension and the second track tension being substantially the same,
the second attack angle being larger than the first attack angle, and
the corner idler wheel being movable from the first position to the second position in a first direction such that track tension initially decreases from the first track tension, and
the corner idler wheel being movable from the second position to the first position in a second direction such that track tension initially decreases from the second track tension, the second direction being opposite the first direction.

2. The track system of claim 1, wherein the adjuster comprises:
a cylinder having a central cylindrical axis extending parallel to the shaft, the shaft being fixed to an inner cylindrical surface of the cylinder, the cylinder being selectively rotatable about the central cylindrical axis; and
a fastener fixed to the frame and selectively fastened to the cylinder to selectively allow and prevent rotation of the cylinder about the central cylindrical axis.

3. The track system of claim 2, wherein the fastener is a cylindrical clamp comprising:
a curved portion extending circumferentially along at least a portion of an outer cylindrical surface of the cylinder.

4. The track system of claim 3, the cylindrical clamp further comprising a tab at each of two ends of the curved portion, the two ends being spaced in a circumferential direction of the cylinder, the tabs being movable relative to one another in the circumferential direction for tightening and loosening of the cylindrical clamp extending around the cylinder.

5. The track system of claim 1, wherein at least a lower surface of the frame between the corner idler wheel and a wheel connected to the contact area portion extends upwards towards the corner idler wheel away from the contact area portion.

6. The track system of claim 5, wherein the wheel connected to the contact area portion is an idler wheel.

7. The track system of claim 1, wherein the plurality of wheels comprises a sprocket wheel connecting the track to the frame, the sprocket wheel being rotatably connected to the frame and operatively connectable to an engine of the vehicle to be rotated thereby, the sprocket wheel engaging an inner surface of the track to drive the track.

8. The track system of claim 7, wherein the sprocket wheel is connected to an upper portion of the frame.

9. A vehicle comprising:
a vehicle frame, the vehicle frame defining a longitudinal direction and a lateral direction;
an engine connected to the vehicle frame; and
at least one track system according to claim 1.

10. The vehicle of claim 9, wherein for at least one of the at least one track system:
the attack angle is a forward attack angle; and
the corner idler wheel is a front corner idler wheel.

11. The vehicle of claim 9, wherein the at least one track system comprises:
a front left track system;
a front right track system;
a rear left track system; and
a rear right track system,
wherein at least one of the front left track system, the front right track system, the rear left track system, and the rear right track system is operatively connected to the engine.

12. A track system for a vehicle traveling on a ground, the track system comprising:
a frame;
an endless track connected to the frame by a plurality of wheels, each of the plurality of wheels being rotatably connected to the frame;
a contact area portion of the track supporting the vehicle on the ground when the track system is on the vehicle, the vehicle is on the ground, and the ground is flat;
a shaft movably connected to the frame;
a corner idler wheel of the plurality of wheels being rotatably mounted on the shaft, a portion of the track extending from the corner idler wheel towards the contact area portion defining an attack angle with respect to the flat ground; and
an adjuster movably connecting the shaft to the frame, the corner idler wheel being thereby movable at least between a first position and a second position,
the track having a first track tension and the attack angle being a first attack angle when the corner idler wheel is in the first position,
the track having a second track tension and the attack angle being a second attack angle when the corner idler wheel is in the second position,
the first track tension and the second track tension being substantially the same, and
the second attack angle being larger than the first attack angle,
the adjuster comprising:
a slot defined in a plate fixed to the frame, the shaft being received in the slot and moveable therein at least between a first shaft position and a second shaft position corresponding respectively to the first and second positions of the corner idler wheel, the slot comprises a first arm and a second arm connected together and extending at an acute angle with respect to each other, the shaft being disposed in the first arm when in the first shaft position and in the second arm when in the second shaft position; and
a fastener fixed to the shaft and selectively fastening the plate to the shaft at least in the first shaft position and the second shaft position.

13. A track system for a vehicle traveling on a ground, the track system comprising:
a frame;
an endless track connected to the frame by a plurality of wheels, each of the plurality of wheels being rotatably connected to the frame;
a contact area portion of the track supporting the vehicle on the ground when the track system is on the vehicle, the vehicle is on the ground, and the ground is flat;
a shaft movably connected to the frame;
a corner idler wheel of the plurality of wheels being rotatably mounted on the shaft;
a portion of the track extending from the corner idler wheel towards the contact area portion defining an attack angle with respect to the flat ground; and
an adjuster movably connecting the shaft to the frame, the corner idler wheel being thereby movable at least between a first position and a second position, the adjuster having a cylinder defining a central cylindrical axis, the cylindrical axis being parallel to the shaft,
when the corner idler wheel is in the first position,
the track having a first track tension,
the attack angle being a first attack angle, and
the shaft being on a first side of a plane containing the cylindrical axis and being parallel to the contact area portion of the track,
when the corner idler wheel is in the second position,
the track having a second track tension, the first track tension and the second track tension being substantially the same,
the attack angle being a second attack angle, the second attack angle being larger than the first attack angle,
the shaft being on a second side of the plane, the second side being opposite the first side.

14. The track system of claim 13, wherein:
the corner idler wheel is movable from the first position to the second position in a first direction such that track tension initially decreases from the first track tension, and
the corner idler wheel is movable from the second position to the first position in a second direction such that track tension initially decreases from the second track tension, the second direction being opposite the first direction.
